(19) United States
(12) Patent Application Publication
(10) Pub. No.: US 2006/0056080 A1
(43) Pub. Date: Mar. 16, 2006

(54) Optical pickup unit comprising an optical pickup actuator wobblably held in an optical base

(75) Inventors: Masayoshi Sugawara, Yamagata (JP); Masayuki Itagaki, Yamagata (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 11/158,715

(22) Filed: Jun. 22, 2005

(30) Foreign Application Priority Data
Aug. 30, 2004 (JP) 2004-250071

(51) Int. Cl. G02B 7/02

(52) U.S. Cl. 359/813

(57) ABSTRACT

An optical pickup unit (100A) according to this invention has an optical pickup actuator (200) for wobblably supporting an objective lens (71) and an optical base (300) having an aperture (300a) for receiving the optical pickup actuator. The optical pickup actuator (200) received in the aperture (300a) is wobblably held in the optical base (300) by using elastic resin material (91A).

This application claims priority to prior Japanese patent application JP 2004-250071, the disclosure of which is incorporated herein by reference.

### BACKGROUND OF THE INVENTION

This invention relates to an optical pickup unit for use in an optical disc drive and, in particular, to an optical pickup unit suitable for an optical disc drive for recording/reproducing data in/from two types of optical discs having different recording density.

There are, as optical discs, DVDs (digital versatile discs or digital video discs), CDs (compact discs), and so on. In the manner which is well known in the art, in DVD apparatuses, there is one in which a particular optical pickup unit is mounted in order to enable to record/reproduce data in/from both of the DVD and the CD. The particular optical pickup unit of the type is for carrying out recording or reproducing by selectively using two kinds of laser beams, namely, a laser beam having short wavelength (wavelength band of 650 nm) for the DVD and a laser beam having a long wavelength (wavelength band of 780 nm) for the CD. The particular optical pickup unit is called a two-wavelength handling optical pickup unit.

The two-wavelength handling optical pickup unit of the type described comprises a first laser diode (LD) for emitting the laser beam having the short wavelength for the DVD and a second laser diode (LD) for emitting the laser beam having the long wavelength for the CD. Such a two-wavelength handling optical pickup unit is disclosed in Japanese Unexamined Patent Application Publication No. 2003-272220 or JP-A 2003-272220.

The optical pickup unit comprises an optical pickup actuator for wobblably supporting an objective lens and an optical base having an aperture for receiving the optical pickup actuator. In a conventional optical pickup unit, the optical pickup actuator received in the aperture of the optical base is adhesively fixed to the optical base by applying an UV adhesive agent having high hardness in a gap between the optical pickup actuator and the optical base at a plurality of points.

At any rate, the optical disc drive of the type described develops a tendency to thin or slim so as to have a low height size. As a result, it is necessary to thin an optical pickup actuator which is a main portion of the optical pickup unit. As a result, it is difficult to keep balance of the optical pickup actuator due to manufacture dispersion of the optical pickup actuator. Accordingly, resonance occurs in a conventional optical pickup.

### SUMMARY OF THE INVENTION

It is therefore an object of the present invention to provide an optical pickup unit which is capable of suppressing resonance.

It is another object of the present invention to provide an optical pickup unit which is capable of thinning the optical pickup unit.

Other objects of this invention will become clear as the description proceeds.

On describing the gist of this invention, it is possible to be understood that an optical pickup unit comprises an optical pickup actuator for wobblably supporting an objective lens and an optical base having an aperture for receiving the optical pickup actuator. According to an aspect of this invention, the optical pickup actuator received in the aperture is wobblably held in the optical base by using elastic resin material.

In the afore-mentioned optical pickup unit, the elastic resin material may be made of a UV adhesive agent having high damping. The UV adhesive agent having high damping may be modified acrylate. The optical pickup actuator received in the aperture may be wobblably held in the optical base by applying the elastic resin material in a gap between the optical pickup actuator and the optical base at a plurality of points. Alternatively, the optical pickup actuator received in the aperture may be wobblably held in the optical base by applying the elastic resin material in a gap between the optical pickup actuator and the optical base along overall circumference.

On describing the gist of this invention, it is possible to be understood that a method is for manufacturing an optical pickup unit. According to an aspect of this invention, the method comprises the steps of preparing an optical pickup actuator for wobblably supporting an objective lens, of preparing an optical base having an aperture for receiving the optical pickup actuator, and of wobblably holding said optical pickup actuator received in the aperture in said optical base by using elastic resin material.

In the afore-mentioned method, the elastic resin material may be made of a UV adhesive agent having high damping. The UV adhesive agent having high damping may be modified acrylate. The wobblably holding step may wobblably hold the optical pickup actuator received in the aperture in the optical base by applying the elastic resin material in a gap between the optical pickup actuator and the optical base at a plurality of points. Alternatively, the wobblably holding step may wobblably hold the optical pickup actuator received in the aperture in the optical base by applying the elastic resin material in a gap between the optical pickup actuator and the optical base along overall circumference.

### BRIEF DESCRIPTION OF THE DRAWINGS

FIG. 1 is an exploded perspective view of an optical pickup actuator in a two-wavelength handling optical pickup unit;

FIG. 2 is a perspective view of the optical pickup actuator illustrated in FIG. 1 after assembled;

FIG. 3A is a plan view of the optical pickup actuator illustrated in FIG. 2;

FIG. 3B is a front view of the optical pickup actuator illustrated in FIG. 2

FIG. 3C is a left-hand side view of the optical pickup actuator illustrated in FIG. 2;

FIG. 3D is a right-hand side view of the optical pickup actuator illustrated in FIG. 2;

FIG. 3E is a bottom view of the optical pickup actuator illustrated in FIG. 2;

FIG. 4 is a perspective view of a conventional two-wavelength handling optical pickup unit wherein the optical pickup actuator illustrated in FIG. 2 is mounted on an optical base;

FIG. 5 is a bottom view of the conventional two-wavelength handling optical pickup unit wherein the optical pickup actuator illustrated in FIG. 2 is mounted on the optical base;

FIG. 6A is a plan view of the optical base in which the optical pickup actuator illustrated in FIG. 2 is mounted;

FIG. 6B is a front view of the optical base;

FIG. 6C is a bottom view of the optical base;

FIGS. 7A and 7B show a Bode diagram (a frequency characteristic) of the conventional optical pickup unit;

FIG. 8 is a bottom view of an optical pickup unit according to a first embodiment of this invention;

FIGS. 9A and 9B show a Bode diagram (a frequency characteristic) of the optical pickup unit illustrated in FIG. 8; and

FIG. 10 is a bottom view of an optical pickup unit according to a second embodiment of this invention.

### DESCRIPTION OF THE PREFERRED EMBODIMENTS

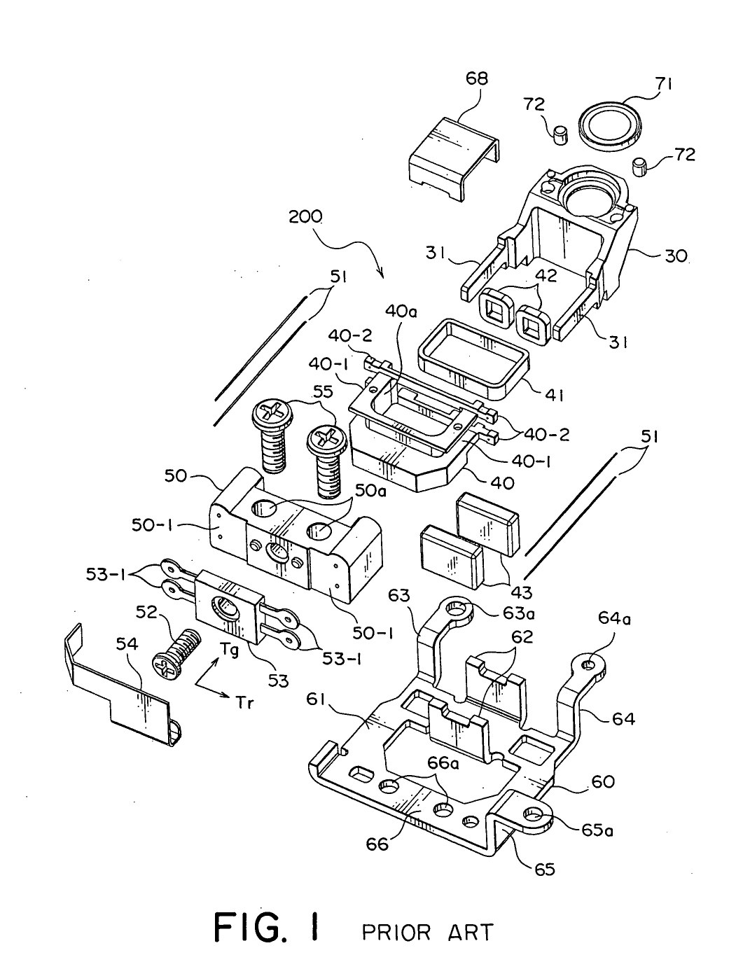

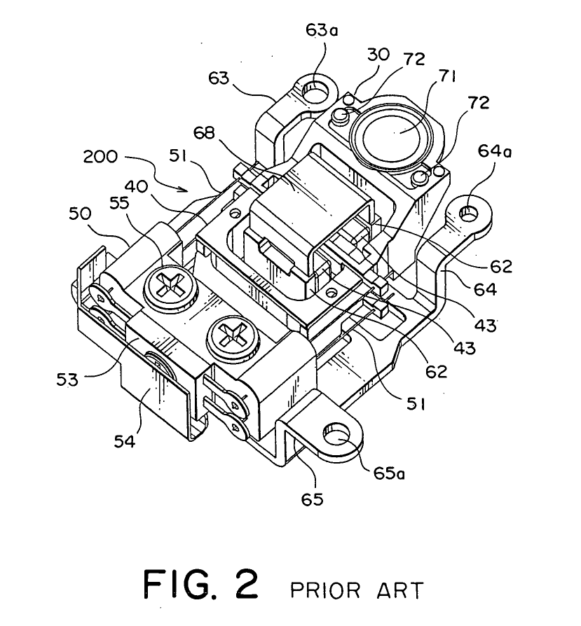

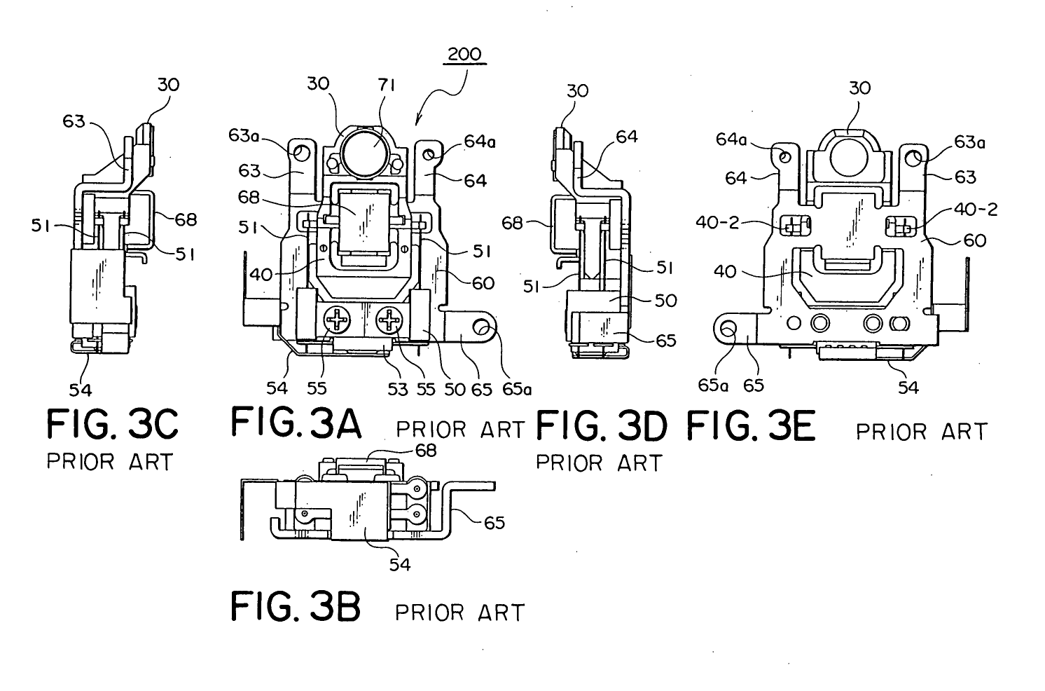

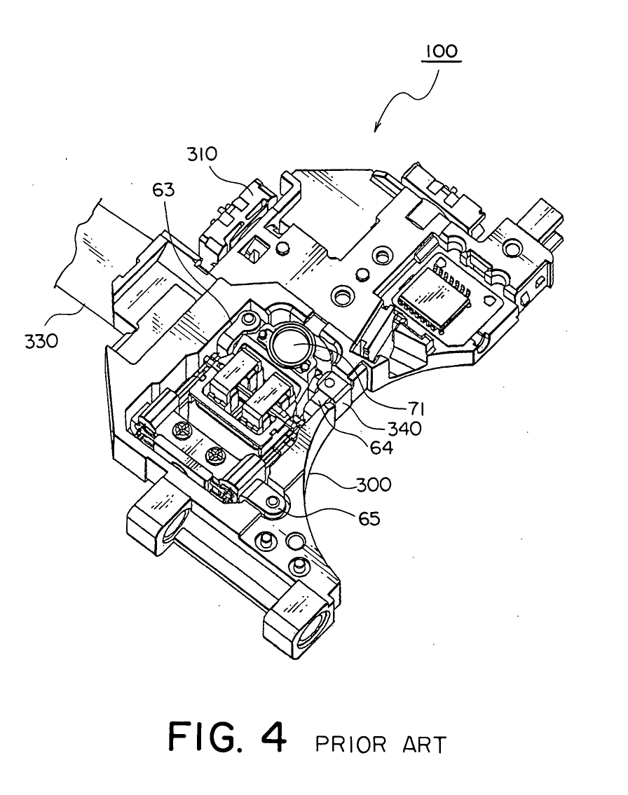

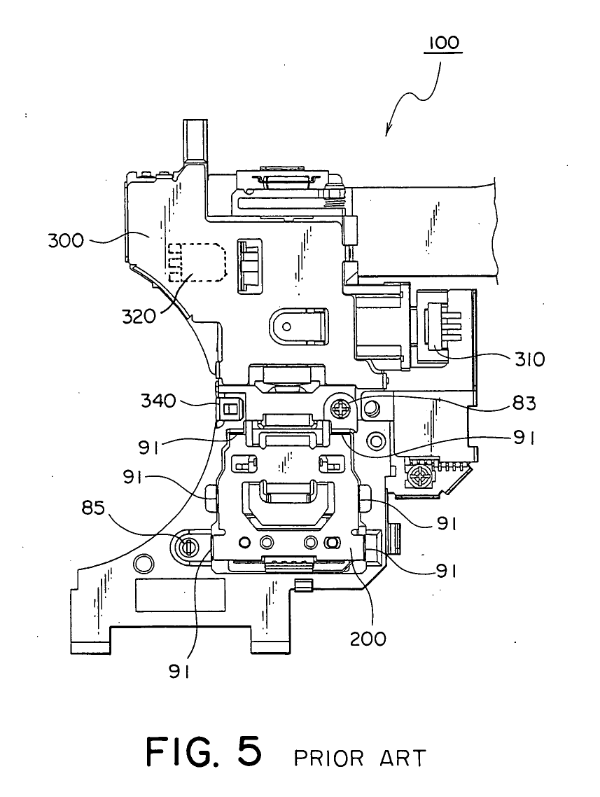

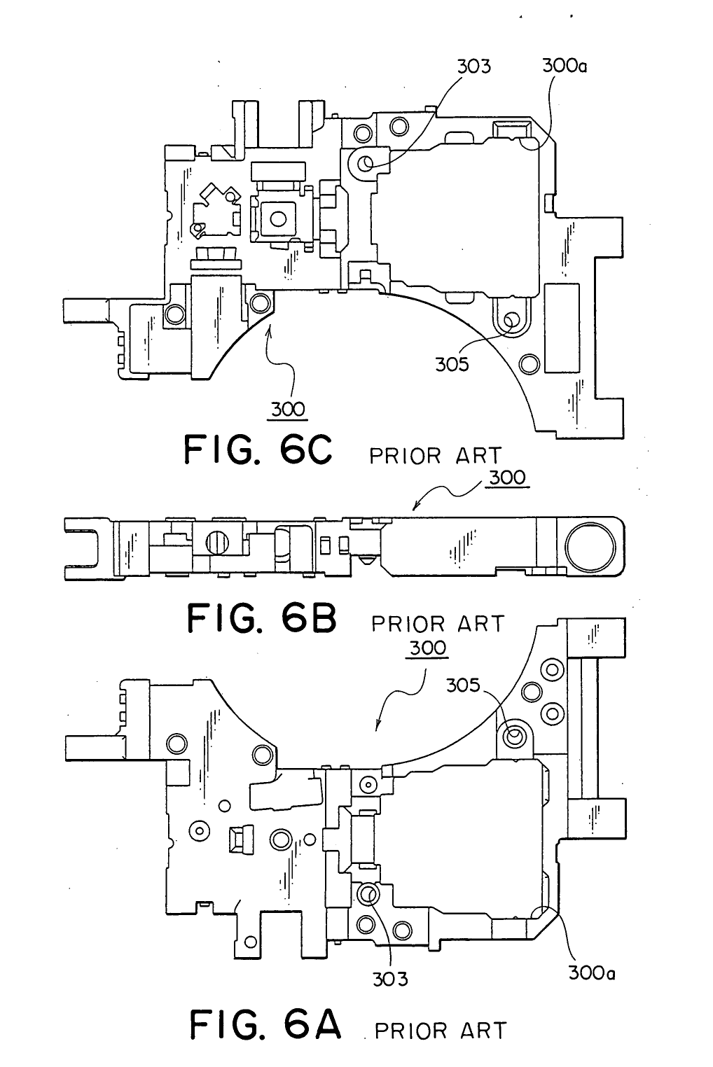

Referring to FIG. 1, 2, 3A, 3B, 3C, 3D, 3E, 4, 5, 6A, 6B, and 6C, a conventional two-wavelength handling optical pickup unit 100 will be described at first in order to facilitate an understanding of the present invention. FIG. 1 is an exploded perspective view of an optical pickup actuator 200 in the two-wavelength handling optical pickup unit 100. FIG. 2 is a perspective view of the optical pickup actuator 200 illustrated in FIG. 1 after assembled. FIG. 3A is a plan view of the optical pickup actuator 200 illustrated in FIG. 2. FIG. 3B is a front view of the optical pickup actuator 200 illustrated in FIG. 2. FIG. 3C is a left-hand side view of the optical pickup actuator 200 illustrated in FIG. 2. FIG. 3D is a right-hand side view of the optical pickup actuator 200 illustrated in FIG. 2. FIG. 3E is a bottom view of the optical pickup actuator 200 illustrated in FIG. 2. FIG. 4 is a perspective view of the conventional two-wavelength handling optical pickup unit 100 wherein the optical pickup actuator 200 illustrated in FIG. 2 is mounted on an optical base 300. FIG. 5 is a bottom view of the conventional two-wavelength handling optical pickup unit 100 wherein the optical pickup actuator 200 illustrated in FIG. 2 is mounted on the optical base 300. FIG. 6A is a plan view of the optical base 300 in which the optical pickup actuator 200 illustrated in FIG. 2 is mounted. FIG. 6B is a front view of the optical base 300. FIG. 6C is a bottom view of the optical base 300.

In FIG. 1, the optical pickup actuator 200 comprises an objective lens holder (which will later be called a lens holder) 30, a bobbin 40, a damper base 50, and a yoke 60. In FIG. 1, a longitudinal direction of the optical pickup actuator 200 is depicted at a tangential direction Tg and a width direction thereof is depicted at a tracking direction Tr. The tangential direction Tg may be called the longitudinal direction while the tracking direction Tr may be called the width direction.

The lens holder 30 is for holding an objective lens 71. The lens holder 30 comprises two arms 31 extending in the longitudinal direction Tg toward the damper base 50. The bobbin 40 is used for winding a focusing coil 41 and has an aperture 40a in which magnets and rising portions of the yoke 60 (both of which will later be described) are received at a center thereof. The bobbin 40 further comprises grooves 40-1 for receiving the arms 31 at both side in the longitudinal direction Tg. That is, the bobbin 40 is assembled in the lens holder 30 by fitting the arms 31 in the grooves 40-1. At an outer wall faced to the lens holder 30 in the bobbin 40, two tracking coils 42 are mounted in the width direction in order. When the bobbin 40 is assembled with the lens holder 30, a little gap is formed between the tracking coils 42 mounted on the above-mentioned outer wall of the bobbin 40 and an inner wall of the lens holder 30. This reason will later be described.

The damper base 50 comprises supporting portions 50-1 at both sides in the longitudinal direction Tg. Specifically, each of the supporting portions 50-1 is made so as to form a pipe-shaped body with a bottom and has an opening faced the lens holder 30. In the supporting portions 50-1 at the both sides, paired suspension wires 51 up and down are mounted. That is, each suspension wire 51 has an end which penetrates a bottom portion of the piped-shaped body of the supporting portion 50-1 and which is fixed in the supporting portion 50-1 at a stuck portion. Each suspension wire 51 has another end which is fixed in one of fixing portions 40-1 provided with the bobbin 40 in the width direction at both sides. That is, the other end of each suspension wire 51 penetrates the corresponding fixing portion 40-1 and is fixed to the fixing portion 40-1 at a stuck portion. In a side wall opposed to the lens holder 30 in the damper base 50, a terminal plate 53 is mounted by a screw 52. The terminal plate 53 comprises four terminals 53-1 which are connected to the ends of the suspension wires 51 penetrated from the supporting portions 50-1 by soldering. On the terminal plate 53, a flexible printed wiring board 54 for connecting the four terminals 53-1 with an external circuit (not shown).

The yoke 60 is disposed under the bobbin 40 and the damper base 50. The yoke 60 comprises a bottom portion 61, two rising portions 62, 62, and three L-shaped portions 63, 64, and 65. The two rising portions 62, 62 are formed so as to rise from the bottom portion 61 by cutting and rising. The three L-shaped portions 63-65 are formed so as to rise from the bottom portion 61 by cutting, rising, and bending. The two rising portions 62, 62 have inner surfaces on which magnets 43 are mounted. The three L-shaped portions 63-65 are used on skew angle adjustment which will later be described and have threaded hole or through holes 63a, 64a, and 65a in upper surfaces parallel with the bottom portion 61. A part of the bottom portion 61, namely, a portion opposed to the rising portions 62 is used as a fixing portion 66 for mounting and fixing the damper base 50 thereon. That is, the damper base 50 has two holes 50a penetrating in up and down. On the other hand, the fixing portion 66 has two threaded holes 66a corresponding to the two holes 50a. By threading two screws 55 from an upward of the damper base 50 toward the two threaded holes 66a downwards, the damper base 50 is fixed on the fixing portion 66 of the yoke 60.

Mounting of the damper base 50 to the yoke 60 is carried out after assembling of the above-mentioned elements is carried out. Specifically, after the bobbin 40 on which the focusing coil 41 and the tracking coils 42 are mounted is assembled to the lens holder 30, the suspension wires 51 connect the bobbin 40 with the damper base 50. On the other hand, the magnets 43 are mounted on the yoke 60. Thereafter, the damper base 50 is fixed on the yoke 60 with the two rising portions 62 inserted in the aperture 40a of the bobbin 40 and the above-mentioned gap between the bobbin 40 and the lens holder 30, respectively.

FIGS. 2 and 3A through 3E show the optical pickup actuator 200 assembled in the manner which is described above. The two rising portions 62 have upper ends to which an upper yoke 68 is assembled to form a closed magnetic circuit. On the lens holder 30, two bumpers 72 are mounted with the objective lens 71 inserted between them.

FIGS. 4 and 5 are the perspective view and the bottom view of the optical pickup unit 100 wherein the optical pickup actuator 200 is mounted on the optical base 300, respectively. Inasmuch as the optical pickup unit 100 is the two-wavelength handling type in the manner which is described above, two laser diodes 310 and 320, for example, for DVD and CD are mounted on the optical base 300. The optical base 300 further comprises an optical path (not shown) including various optical elements for irradiating laser beams emitted from the two laser diodes 310 and 320 on an optical disc through the objective lens 71 in the optical pickup actuator 200 and for guiding its reflected light to a photodetector. In addition, the optical base 300 is provided with a flexible printed board 330 (only a part thereof is showed) for connecting to the external circuit.

FIGS. 6A through 6C show the optical base 300. FIG. 6A is the plan view of the optical base 300. FIG. 6B is the front view of the optical base 300. FIG. 6C is the bottom view of the optical base 300. The optical base 300 has an aperture 300a for receiving the optical pickup actuator 200.

At any rate, on mounting the optical pickup actuator 200 on the optical base 300, the skew angle adjustment is carried out and then the optical pickup actuator 200 is fixed on the optical base 300.

The skew angle adjustment is carried out by using the three L-shaped portions 63-65. More specifically, in the example being illustrated, in order to operate the L-shaped portion 64 as a fulcrum, the L-shaped portion 64 and the optical base 300 are sandwiched by using a U-shaped spring plate 340. In order to prevent the spring plate 340 from unfastening or slipping out of place, the spring plate 340 has a semispherical projection (not shown) which is fitted in the through hole 64a of the L-shaped portion 64. The optical base 300 has through holes 303 and 305 for penetrating screws 83 and 85 at positions corresponding to the threaded holes 63a and 65a of the L-shaped portions 63 and 65. The screws 83 and 85 are threaded in the threaded holes 63a and 65a through the above-mentioned through holes 303 and 305 of the optical base 300 from a lower surface in FIG. 4. By fine adjusting threading amounts of the screws 83 and 85, the optical pickup actuator 200 is rotated in regard to a mounting surface (a reference surface) of the optical base 300 to set a skew angle to a predetermined angle. After this setting work comes to end, the optical pickup actuator 200 is adhesively fixed to the optical base 300 by using an UV adhesive agent 91 having high hardness. In the example being illustrated, the optical pickup actuator 200 received in the aperture 300a of the optical base 300 is adhesively fixed to the optical base 300 by applying the UV adhesive agent 91 having the high hardness in a gap between the optical pickup actuator 200 and the optical base 300 at six points.

However, the optical pickup actuator 200 develops a tendency to thin (miniaturize) in the manner which is described above. As a result, it is difficult to keep balance of the optical pickup actuator 200 due to manufacture dispersion of the optical pickup actuator 200. The “balance” of the optical pickup actuator 200 means that a center of balance in the lens holder 30 of the optical pickup actuator 200 is consistent with a driving center defined by positions of the tracking coils 42 and the focusing coil 41. That is, there is a discrepancy between the center of balance in the lens holder 30 and the driving center due to miniaturization (manufacture dispersion) of the optical pickup actuator 200. Accordingly, resonance occurs in the conventional optical pickup unit 100, as mentioned in the preamble of the instant specification.

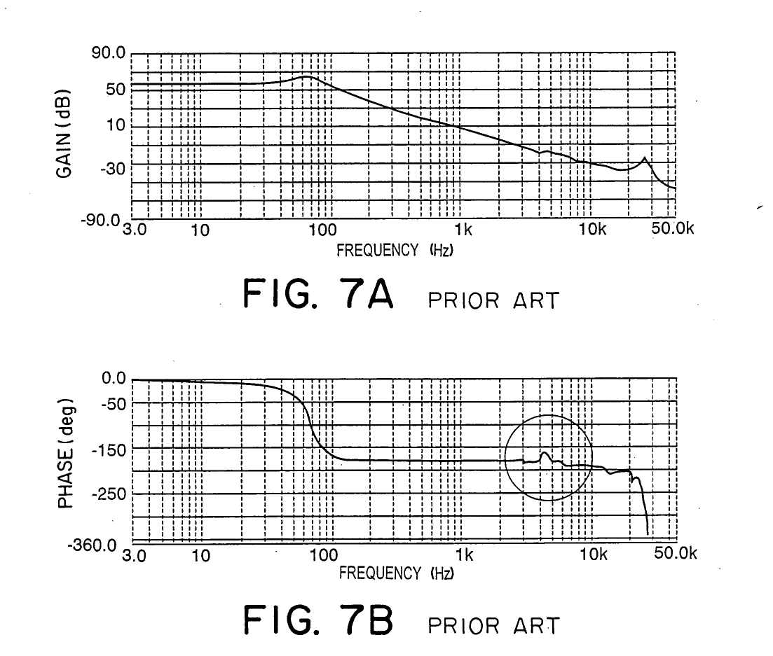

FIGS. 7A and 7B show a Bode diagram (a frequency characteristic) of the conventional optical pickup unit 100. FIG. 7A shows a gain characteristic of the conventional optical pickup unit 100. In FIG. 7A, the abscissa represents a frequency (Hz) in logarithm scale and the ordinate represents a gain (dB). FIG. 7B shows a phase characteristic of the conventional optical pickup unit 100. In FIG. 7B, the abscissa represents a frequency (Hz) in logarithm scale and the ordinate represents a phase (deg). As shown in a position enclosed by a circle in FIG. 7B, it is understood that the conventional optical pickup unit is disadvantageous in that resonance occurs.

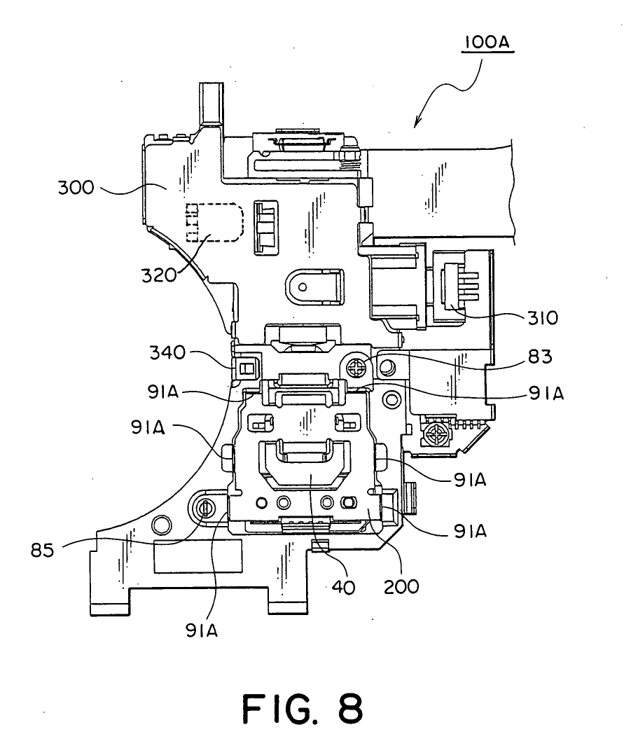

Referring to FIG. 8, the description will proceed to an optical pickup unit 100A according to a first embodiment of this invention. The illustrated optical pickup unit 100A is also a two-wavelength handling type. FIG. 8 is a bottom view of the optical pickup unit 100A according to the first embodiment of this invention.

The illustrated optical pickup unit 100A is similar in structure to the conventional optical pickup unit 100 illustrated in FIG. 5 except that a UV adhesive agent 91A having high damping is used in lieu of the UV adhesive agent 91 having high hardness. Accordingly, the same reference symbols are attached to those having similar functions in the conventional optical pickup unit and description thereof is omitted for the purpose of simplification of the description.

The optical pickup actuator 200 received in the aperture 300a of the optical base 300 is wobblably held in the optical base 300 by using the UV adhesive agent 91A having high damping. The UV adhesive agent 91A having high damping is a kind of elastic resin material consisting of, for example, modified acrylate which is a kind of acrylic resin.

In the example being illustrated, the optical pickup actuator 200 received in the aperture 300a of the optical base 300 is wobblably fixed to the optical base 300 by applying the UV adhesive agent 91A having the high damping in the gap between the optical pickup actuator 200 and the optical base 300 at six points.

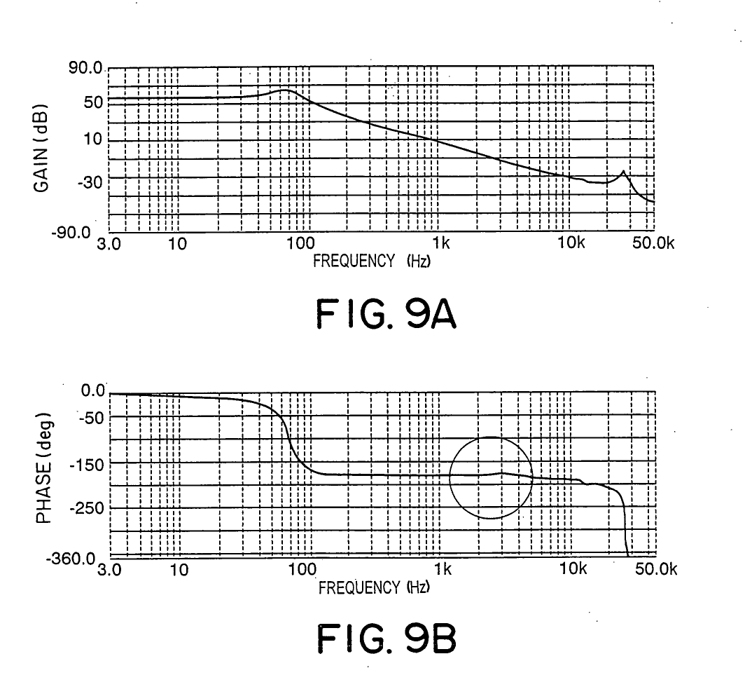

FIGS. 9A and 9B show a Bode diagram (a frequency characteristic) of the optical pickup unit 100A. FIG. 9A shows a gain characteristic of the optical pickup unit 100A. In FIG. 9A, the abscissa represents a frequency (Hz) in logarithm scale and the ordinate represents a gain (dB). FIG. 9B shows a phase characteristic of the optical pickup unit 100A. In FIG. 9B, the abscissa represents a frequency (Hz) in logarithm scale and the ordinate represents a phase (deg). As shown in a position enclosed by a circle in FIG. 9B, it is understood that the optical pickup unit 100A is advantageous in that it is possible to suppress resonance of the optical pickup unit 100A. In other words, it is possible for the optical pickup unit 100A to suppress malfunction due to manufacture dispersion of the optical pickup actuator 200.

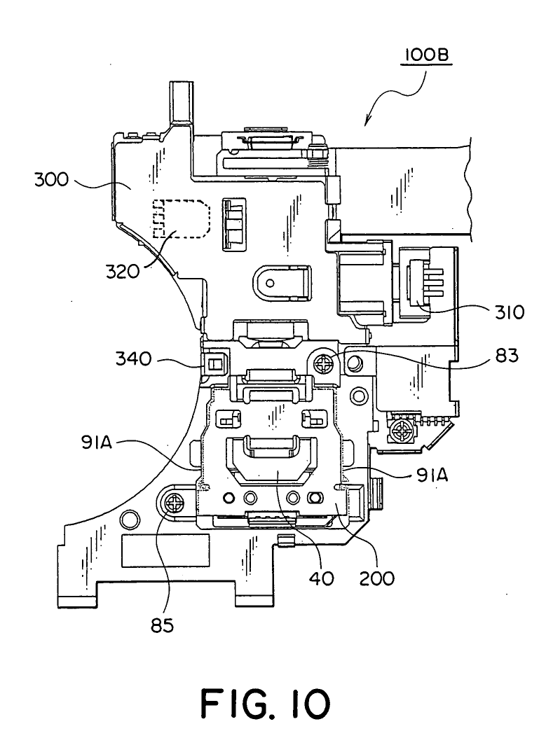

Referring to FIG. 10, the description will proceed to an optical pickup unit 100B according to a second embodiment of this invention. The illustrated optical pickup unit 100B is also a two-wavelength handling type. FIG. 10 is a bottom view of the optical pickup unit 100B according to the second embodiment of this invention.

The illustrated optical pickup unit 100B is similar in structure to the optical pickup unit 100A illustrated in FIG. 8 except that a way of applying the UV adhesive agent 91A having high damping is different from each other. That is, in the example being illustrated, the optical pickup actuator 200 received in the aperture 300a of the optical base 300 is wobblably fixed to the optical base 300 by applying the UV adhesive agent 91A having the high damping in the gap between the optical pickup actuator 200 and the optical base 300 along overall circumference.

In the optical pickup unit 100B according to the second embodiment of this invention, it is possible to suppress resonance of the optical pickup unit 100B in the manner as the frequency characteristic of the optical pickup unit shown in FIGS. 9A and 9B. In other words, it is possible for the optical pickup unit 100B to suppress malfunction due to manufacture dispersion of the optical pickup actuator 200.

While this invention has thus far been described in conjunction with a few embodiments thereof, it will now be readily possible for those skilled in the art to put this invention into various other manners without departing from the scope of this invention. For example, the optical pickup unit according to this invention may be best suitable to optical disc drives, particularly, to thin-type optical disc drives and may be applicable to all of optical disc drives for reading recorded information or for writing information from/to optical discs (CD, CD-ROM, CD-R, CD-RW, DVD-ROM, DVD+R, DVD-R, DVD-RAM, DVD+RW, DVD-RW, or the like). Needless to say, this invention is not restricted to the two-wavelength handling optical pickup units, this invention may be applicable to one-wavelength handling optical pickup units.

What is claimed is:

1. An optical pickup unit comprising:
an optical pickup actuator for wobblably supporting an objective lens; and
an optical base having an aperture for receiving said optical pickup actuator, wherein said optical pickup actuator received in the aperture is wobblably held in said optical base by using elastic resin material.

2. The optical pickup unit as claimed in claim 1, wherein said elastic resin material is made of a UV adhesive agent having high damping.

3. The optical pickup unit as claimed in claim 2, wherein said UV adhesive agent having high damping is modified acrylate.

4. The optical pickup unit as claimed in claim 1, wherein said optical pickup actuator received in the aperture is wobblably held in said optical base by applying said elastic resin material in a gap between said optical pickup actuator and said optical base at a plurality of points.

5. The optical pickup unit as claimed in claim 1, wherein said optical pickup actuator received in the aperture is wobblably held in said optical base by applying said elastic resin material in a gap between said optical pickup actuator and said optical base along overall circumference.

6. A method of manufacturing an optical pickup unit, said method comprising the steps of:
preparing an optical pickup actuator for wobblably supporting an objective lens;
preparing an optical base having an aperture for receiving said optical pickup actuator; and
wobblably holding said optical pickup actuator received in the aperture in said optical base by using elastic resin material.

7. The method as claimed in claim 6, wherein said elastic resin material is made of a UV adhesive agent having high damping.

8. The method as claimed in claim 7, wherein said UV adhesive agent having high damping is modified acrylate.

9. The method as claimed in claim 6, wherein said wobblably holding step wobblably holds said optical pickup actuator received in the aperture in said optical base by applying said elastic resin material in a gap between said optical pickup actuator and said optical base at a plurality of points.

10. The method as claimed in claim 6, wherein said wobblably holding step wobblably holds said optical pickup actuator received in the aperture in said optical base by applying said elastic resin material in a gap between said optical pickup actuator and said optical base along overall circumference.
